(19) United States
(12) Patent Application Publication
(10) Pub. No.: US 2016/0077653 A1
(43) Pub. Date: Mar. 17, 2016

(54) METHOD AND APPARATUS FOR DISPLAYING OBJECT

(71) Applicant: SAMSUNG ELECTRONICS CO., LTD., Suwon-si (KR)

(72) Inventor: Hyun-kwon CHUNG, Seoul (KR)

(73) Assignee: SAMSUNG ELECTRONICS CO., LTD., Suwon-si (KR)

(21) Appl. No.: 14/742,775

(22) Filed: Jun. 18, 2015

(30) Foreign Application Priority Data
Sep. 15, 2014 (KR) 10-2014-0122030

(51) Int. Cl. G06F 3/041; G06F 3/0484; G06F 3/0488; G06F 3/0481

(52) U.S. Cl. CPC G06F 3/0416; G06F 3/0412; G06F 3/04817; G06F 3/04842; G06F 3/0488; G06F 2203/04104

(57) ABSTRACT

A method of displaying an object on a device, is provided. The method includes generating identification information of objects of interest selected from objects available for displaying on the device based on preset sequence information, and determining sequence information of an object displayed on the device among the available objects. The method further includes based on an input, displaying an object of interest corresponding to previous sequence information or following sequence information of the determined sequence information, among the objects of interest.

### CROSS-REFERENCE TO RELATED APPLICATION

This application claims priority from Korean Patent Application No. 10-2014-0122030, filed on Sep. 15, 2014, in the Korean Intellectual Property Office, the disclosure of which is hereby incorporated by reference in its entirety.

### BACKGROUND

1. Field

Aspects of exemplary embodiments relate to a method and apparatus for displaying an object.

2. Description of the Related Art

With the development of communication technologies and display technologies, contents have been digitized and displayed in electronic devices. A variety of printed media have been digitized and provided to users. For example, a user may receive digitized contents of such media as photos, moving pictures, documents, textbooks, magazines and newspapers through an electronic device with a display device.

User interfaces with a variety of functions have been under development to provide digital contents. In particular, based on the characteristic capable of providing a huge amount of digital contents to users, research on methods of processing and displaying digital contents in order to allow users to easily search for, manage, and edit desired contents have been actively performed.

### SUMMARY

Aspects of exemplary embodiments include a method for determining an object of interest set by a user and providing the object to the user when objects are displayed through a device, and a device for performing the method.

Additional aspects will be set forth in part in the description that follows and, in part, will be apparent from the description, or may be learned by practice of the presented exemplary embodiments.

According to an aspect of an exemplary embodiment, there is provided a method of displaying an object on a device, the method including generating identification information of objects of interest selected from objects available for displaying on the device based on preset sequence information, and determining sequence information of an object displayed on the device among the available objects. The method further includes based on an input, displaying an object of interest corresponding to previous sequence information or following sequence information of the determined sequence information, among the objects of interest.

The displaying of the object of interest may include based on the input, detecting at least one of objects of interest corresponding to the previous sequence information or the following sequence information of the determined sequence information determined, among the objects of interest, based on the preset sequence information, and sequentially displaying the detected at least one of the objects of interest.

The generating of the identification information may include selecting, as an object of interest, an object in which an identifier is displayed from the available objects.

The generating of the identification information may include determining a type of the identifier, and generating the identification information to be different from each other based on the determined type of the identifier.

The method may further include displaying identification information regions indicating respective objects of interest, the identification information regions being distinguishable based on an identifier displayed in each of the objects of interest.

The displaying of the object of interest may include displaying, in an identification information region among the identification information regions, an object of interest among the objects of interest that corresponds to the identification information region, based on a selection of the identification information region.

The method may further include displaying thumbnail images of the respective object of interests.

The displaying of the identification information regions may include displaying the identification information regions on a side surface of the device based on sequence information of the objects of interest.

The displaying of the identification information regions may include detecting a motion, and based on the detected motion, displaying a part of the identification information regions.

The displaying of the part of the identification information regions may include in response to the detected motion being a motion from a side surface of the device to another side surface of the device, displaying another part of the identification information regions.

A non-transitory computer-readable storage medium may store a program including instructions for causing a computer to perform the method.

According to an aspect of another exemplary embodiment, there is provided a device for displaying an object, the device including a controller configured to generate identification information of objects of interest selected from objects available for displaying on the device based on preset sequence information, and determine sequence information of an object displayed on the device among the available objects. The device further includes an outputter configured to, based on an input, display an object of interest corresponding to previous sequence information or following sequence information of the determined sequence information, among the objects of interest.

The controller may be further configured to, based on the input, detect at least one of objects of interest corresponding to the previous sequence information or the following sequence information of the determined sequence information determined, among the objects of interest, based on the preset sequence information, and the outputter may be configured to sequentially display the detected at least one of the objects of interest.

The controller may be configured to select, as an object of interest, an object in which an identifier is displayed from the available objects.

The controller may be configured to determine a type of the identifier, and generate the identification information to be different from each other based on the determined type of the identifier.

The outputter may be further configured to display identification information regions indicating respective objects of interest, the identification information regions being distinguishable based on an identifier displayed in each of the objects of interest.

The outputter may be configured to display, in an identification information region among the identification information regions, an object of interest among the objects of interest that corresponds to the identification information region, based on a selection of the identification information region.

The outputter may be further configured to display thumbnail images of the respective object of interests.

The outputter may be configured to display the identification information regions on a side surface of the device based on sequence information of the objects of interest.

The device may further include an inputter configured to detect a motion, and the outputter may be configured to, based on the detected motion, display a part of the identification information regions.

The outputter may be further configured to in response to the detected motion being a motion from a side surface of the device to another side surface of the device, display another part of the identification information regions.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a conceptual diagram illustrating a method of displaying an object on a device according to an exemplary embodiment;

FIG. 2 is a flowchart illustrating a method for a device to display an object according to an exemplary embodiment;

FIG. 3 is a flowchart illustrating a method for a device to display identification information regions based on a type of an identifier displayed on objects according to an exemplary embodiment;

FIG. 4 is a diagram illustrating a method for a device to determine different types of identifiers according to an exemplary embodiment;

FIG. 5 is a diagram illustrating a method for a device to display information of different types of identifiers according to an exemplary embodiment;

FIG. 6 is a diagram illustrating a method for a device to display identification information regions on a device according to an exemplary embodiment;

FIG. 7 is a diagram illustrating a method for a device to display identification information regions on a device according to another exemplary embodiment;

FIG. 8 is a diagram illustrating a method for a device to display identification information regions based on a user input according to an exemplary embodiment;

FIG. 9 is a diagram illustrating a method for a device to determine a location and a range of an identification information region to be displayed, based on a user input according to an exemplary embodiment;

FIG. 10 is a flowchart illustrating a method for a device to detect a motion of a user and display additional information of objects of interest corresponding to identification information regions according to an exemplary embodiment;

FIG. 11 is a diagram illustrating a method for a device to detect a motion of a user and display thumbnail images of an object of interest according to an exemplary embodiment;

FIG. 12 is a diagram illustrating a method for a device to change thumbnail images displayed on a device based on traveling motions of a user according to an exemplary embodiment; and

FIGS. 13 and 14 are block diagrams illustrating a device for displaying an object according to an exemplary embodiment.

### DETAILED DESCRIPTION OF EXEMPLARY EMBODIMENTS

The terms used in the exemplary embodiments will be briefly explained, and the exemplary embodiments will be explained in detail.

The terms used in the exemplary embodiments are selected from the terms commonly used at present with considering functions in the exemplary embodiments, but this may change according to the intention of those skilled in the art or court decisions, or appearance of new technologies. Also, in some cases, there are terms selected by the applicant's own decision, and in such cases, the meanings will be explained in detail in corresponding parts of the detailed description. Accordingly, the terms used in the exemplary embodiments should be defined, not as simple names, but based on the meanings of the terms and the contents of the exemplary embodiments as a whole.

It will be understood that the terms “comprises” and/or “comprising”, when used in this specification, do not preclude the presence or addition of one or more other features unless otherwise described. Also, the terms such as “ . . . unit” and “ . . . module” indicate a unit for processing at least one function or operation, and this unit may be implemented by hardware or software or combination of hardware and software.

Reference will now be made in detail to exemplary embodiments, examples of which are illustrated in the accompanying drawings, such that one of ordinary skill in the art can easily implement the embodiments. However, the exemplary embodiments may have different forms, and should not be construed as being limited to the descriptions set forth herein. In order to clearly explain the exemplary embodiments, irrelevant parts in drawings are omitted and like reference numerals refer to like elements throughout.

Through the entire specification, an “application” means a series of computer program sets devised for performing predetermined jobs. An application described in this specification may vary. For example, the application may be one for watching an object stored in a device and/or a storage unit on a network, such as gallery applications, scheduler applications, memo applications, and digital book applications, but is not limited to these.

As used herein, the term “and/or” includes any and all combinations of one or more of the associated listed items. Expressions such as “at least one of,” when preceding a list of elements, modify the entire list of elements and do not modify the individual elements of the list.

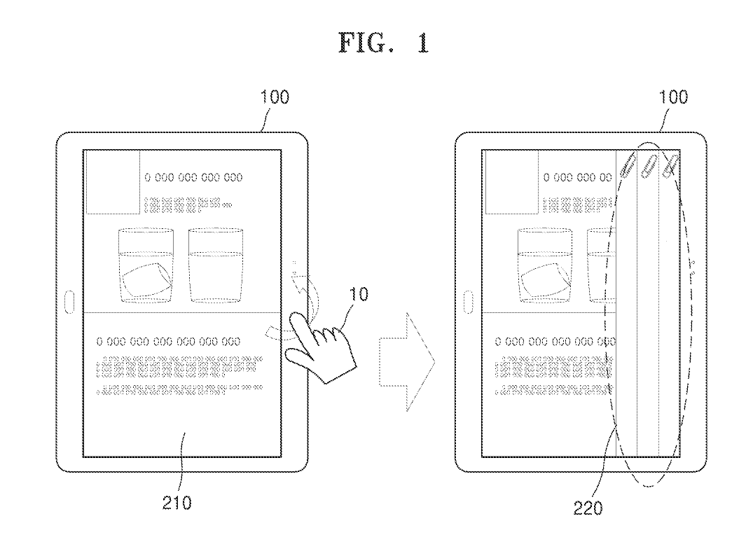

FIG. 1 is a conceptual diagram illustrating a method of displaying an object 210 on a device 100 according to an exemplary embodiment. When the device 100 executes an application, the object 210 related to the execution of the application is displayed on a screen of the device 100. The object 210 related to the execution of the application may be displayed on the screen independently based on preset sequence information. Here, the sequence information includes information of a sequence in which an object is displayed sequentially on the screen of the device 100.

For example, when the device 100 executes a digital book application, each of pages forming the digital book application may be the object 210. Each page forming the digital book application may be sequentially displayed on the screen of the device 100 based on a preset page number.

When the device 100 executes a gallery application according to another exemplary embodiment, each photo stored in the gallery application may be the object 210. Each photo stored in the gallery application may be sequentially displayed on the screen of the device 100 based on a preset sequence such as a stored time.

When the device 100 executes a moving picture application according to another exemplary embodiment, each frame forming the moving pictures may be the object 210. Each frame forming the moving pictures may be sequentially displayed on the screen of the device 100 based on a frame number. However, these are just exemplary embodiments, and other exemplary embodiments are not limited to these.

Meanwhile, the device 100 may determine the displayed object 210 according to a set mode. For example, when the device 100 is set to a first mode, the device 100 may display sequentially at least one object (for example, the object 210) on the device 100 according to preset sequence information as described above.

Meanwhile, the device 100 may detect and display one or more predetermined objects among all objects according to another exemplary embodiment. For example, when the device 100 is set to a second mode, according to the sequence information of the detected predetermined objects, the device 100 may sequentially display the detected predetermined objects on the device 100. Therefore, unlike the first mode, only the predetermined objects among all of the objects may be displayed on the device 100 without displaying at least one unspecified object among all of the objects.

When the device 100 is set to the second mode, the device 100 may determine an identifier displayed on the object 210 according to a user input. For example, the device 100 may determine an identifier displayed on at least one page among a plurality of pages of a digital book. Here, the identifier may include, for example, a bookmark sign, an underline mark, and a page folding mark. Based on a result of the determination, the device 100 may display each object of interest including an identifier on the device 100.

Hereinafter, each of predetermined objects on which identifiers are displayed among objects displayed on the device 100 with an application being executed will be explained as an object of interest.

The device 100 may store information of an object of interest on which an identifier is displayed. For example, the device 100 may store information of an object of interest on which an identifier is displayed among objects, in metadata of the object of interest. When an identification information request input 10 for information of an object of interest from a user is received, the device 100 displays identification information regions 220 indicating respective objects of interest.

Meanwhile, when an application is executed, the device 100 performs an operation corresponding to a detected user input. Here, the user input may be generated not only by a type of input, but also by a combination of different types of inputs. For example, referring to FIG. 1, the device 100 may detect not only each of a touch input and a swiping input, but also a user input combining the touch input and the swiping input. Here, the swiping input means a motion of flicking upwards or downwards a predetermined region of the screen of the device 100 without continuously pressing the region.

A database stored outside or inside of the device 100 includes information of kinds of user inputs that the device 100 may detect, and information of an operation of the device 100 corresponding to each of the user inputs. The device 100 extracts, from the database, information of an operation corresponding to a detected user input, and performs an operation based on the extracted information. The operation corresponding to each of the user inputs may vary according to a kind of an application being executed in the device 100.

When the identification information requesting input 10 that is a combination of a touch input and a swiping input is received, the device 100 may display the identification information regions 220 displaying the respective objects of interest. However, this is just an exemplary embodiment, and other exemplary embodiments are not limited by this. According to a setting of the device 100, the identification information regions 220 displaying the respective objects of interest may be displayed based on a different type of input such as a hovering input.

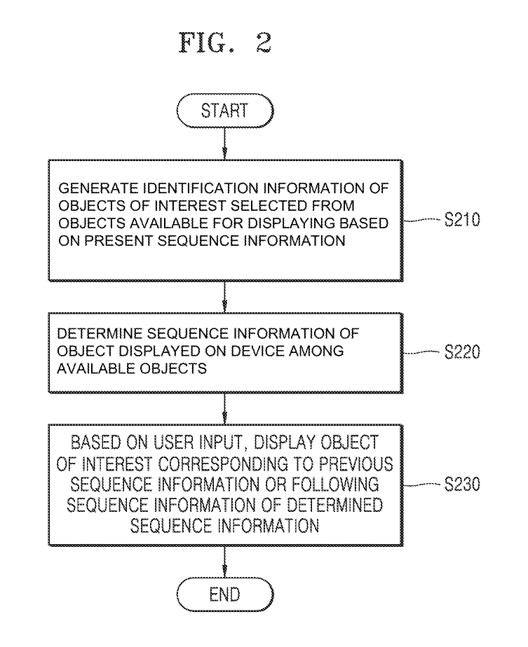

FIG. 2 is a flowchart of a method for the device 100 to display an object according to an exemplary embodiment.

In operation S210, the device 100 generates identification information of objects of interest selected from objects available for displaying based on preset sequence information. Here, the identification information may be generated based on identifiers included in the objects of interest.

In detail, the device 100 may generate identification information of an object on which an identifier is displayed. Here, the identifier may include information displayed on an object such as, for example, a bookmark sign, an underline mark, a page folding mark, and a highlight mark. For example, when a digital book application is executed in the device 100, the user may set a bookmark sign on an n-th page including information of interest. Based on the bookmark sign set on the n-th page, the device 100 may generate identification information on the n-th page. The identification information may be stored in metadata of the n-th page.

In operation S220, the device 100 determines sequence information of the object 210 displayed on the device 100 among of the available objects. For example, the device 100 may determine sequence information of which point, in a sequence of the available objects included in contents, the object 210 currently displayed on the device 100 is positioned.

For example, when an application being executed in the device 100 is a digital book application, the device 100 may determine information of a page number of a page being displayed on the screen, in a page sequence of the digital book application. When the execution of the digital book application starts in the device 100, it may be set that an object to be displayed firstly on the screen of the device 100 is the first page. However, this is just an exemplary embodiment, and other exemplary embodiments are not limited by this.

In operation S230, based on a user input, the device 100 displays an object of interest corresponding to previous sequence information or following sequence information of the determined sequence information, among the objects of interest. For example, if the device 100 receives a tap input from a user, the device 100 may display, on the device 100, an object of interest having sequence information that is the previous or following sequence information of the determined sequence information of the object 210 displayed on the device 100.

Based on a position on the device 100 from which the tap input from the user is received, the device 100 may display the object of interest. For example, if the tap input is obtained on a first side surface of the device 100, the device 100 may display the object of interest having the sequence information that is the previous sequence information of the determined sequence information of the object 210 displayed on the device 100. Also, if the tap input is obtained on a second side surface of the device 100, the device 100 may display the object of interest having the sequence information that is the following sequence information of the determined sequence information of the object 210 displayed on the device 100.

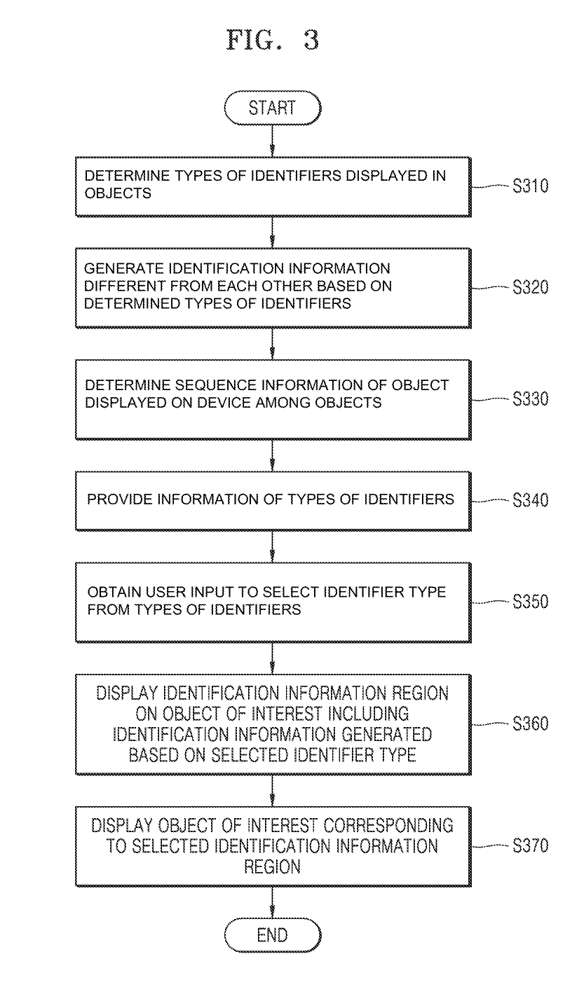

FIG. 3 is a flowchart of a method for a device 100 to display the identification information regions 220 based on a type of an identifier displayed on objects according to an exemplary embodiment.

In operation S310, the device 100 determines types of identifiers displayed in objects. The types of identifiers may be classified according to kinds, shapes and colors of identifiers. The kinds of identifiers may include, for example, a bookmark sign, an underline mark, a highlight mark, and a page folding mark. Also, the shapes of identifiers may be determined by forms and sizes of identifiers.

In operation S320, the device 100 generates identification information different from each other based on the determined types of identifiers. For example, the device 100 may generate the identification information of an identifier of a bookmark sign and identification information of an underline mark, such that the former is different from the latter.

According to another exemplary embodiment, the device 100 may generate identification information of an identifier with a triangle shape and identification information of an identifier with an oval shape, such that the former is different from the latter. Also, according to another exemplary embodiment, the device 100 may generate identification information of a yellow highlight mark and identification information of a blue highlight mark, such that the former is different from the latter.

Meanwhile, different identification information items generated based on respective different types of identifiers may be stored in metadata of objects.

In operation S330, the device 100 determines sequence information of the object 210 displayed on the device 100 among objects. The device 100 may determine sequence information of which point, in a sequence of the objects included in contents, the object 210 currently displayed on the device 100 is positioned. Operation S330 may correspond to operation S220 of FIG. 2.

In operation S340, the device 100 provides information of the types of identifiers. The device 100 may display a list of the types of identifiers displayed in each of objects of interest. In the list of the types of identifiers, additional information of the objects of interest in which identifiers are displayed may be displayed together with information of the types of identifiers.

Here, the additional information of the objects of interest may include information for identifying the objects of interest among objects available to be displayed when an application is executed. For example, title information, sequence information, and thumbnail images of the objects of interest may be included in the additional information.

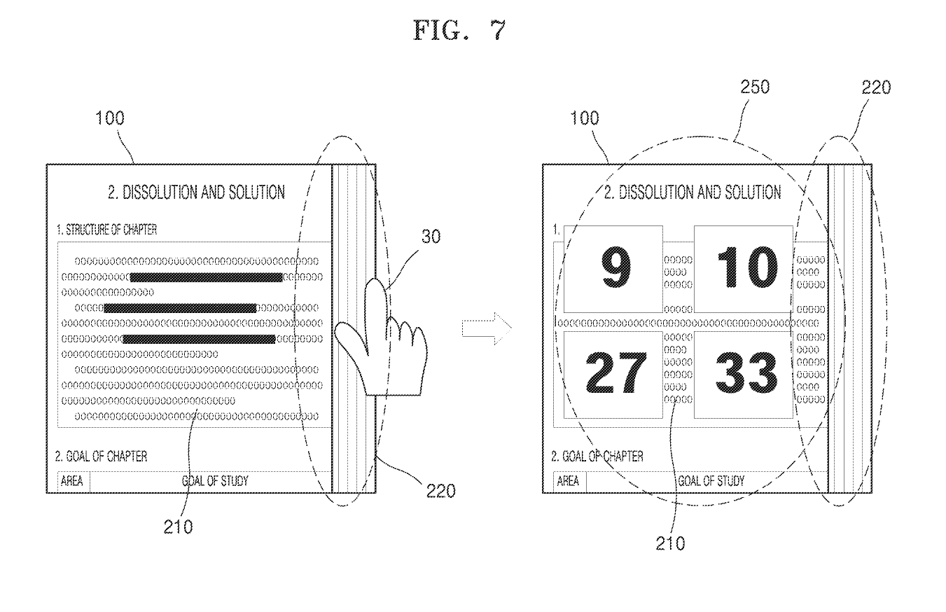

A method for the device 100 to display information of the types of identifiers will be explained in detail later with reference to FIG. 7.

However, this is just an exemplary embodiment, and the device 100 may not display the list of the types of identifiers. Without separately selecting any of the types of identifiers, a user may select an identifier displayed in the object 210 currently displayed on the device 100, and the device 100 may display the identification information regions 220 of the selected identifier. For example, if the user touches a red highlight mark on the object 210 displayed on the device 100 for longer than a preset time, the identification information regions 222 of the objects of interest on which a red highlight mark is displayed may be displayed.

In operation S350, the device 100 obtains a user input to select an identifier type from the types of identifiers. For example, the user may touch, in the list of the types of identifiers, a type of an identifier displayed in an object of interest that is desired to be displayed on the device 100, and thus select the identifier. However, this is just an exemplary embodiment, and the user may select, through a hovering input, an identifier displayed in the object of interest that is desired to be displayed on the device 100.

In operation S360, the device 100 displays an identification information region on an object of interest including identification information generated based on the selected identifier type. The device 100 may display, on a side surface of the screen of the device 100, the identification information region on the object of interest on which the selected identifier type is displayed. For example, when the user selects a bookmark sign as the type of the identifier, identification information regions on objects of interest on which a bookmark sign is included may be displayed on the side surface of the screen of the device 100.

In each of the identification information regions 220, additional information of a corresponding object of interest may be displayed. The additional information of the object of interest may include information for identifying an object of interest among the objects available to be displayed when the application is executed, as described above.

In a predetermined region of the screen, the device 100 may display the identification information regions 220. The device 100 may display identification information regions 220 on at least one side surface of the screen. According to another exemplary embodiment, the device 100 may display the identification information regions 220 in the form of a pop-up window. For example, when the identification information request input 10 is detected in a preset region of the screen, the device 100 may display the pop-up window including the identification information regions 220.

The device 100 may display the identification information regions 220 based on sequence information of objects of interest. For example, when the device 100 determines n-th, (n+3)-th, and (n+4)-th objects of interest, the device 100 may display, based on the sequence information, the identification information regions 220 in order of an n-th identification information region, an (n+3)-th identification information region, and an (n+4)-th identification information region.

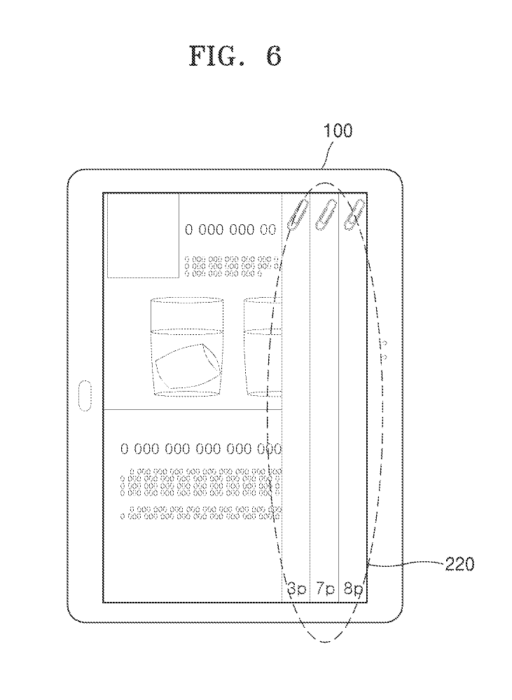

The method for the device 100 to display the identification information regions 220 will be explained in detail later with reference to FIG. 6.

In operation S370, the device 100 displays an object of interest corresponding to a selected identification information region. The device 100 obtains a user input to select at least one of the identification information regions 220. The device 100 displays an object of interest corresponding to the at least one of the identification information regions 220 selected according to the user input. For example, the device 100 may obtain a user input that selects identification information region A corresponding to object of interest A among the identification information regions 220.

The device 100 may replace the object 210 displayed on the screen with an object of interest selected according to the user input. However, this is just an exemplary embodiment, and other exemplary embodiments are not limited by this.

According to another exemplary embodiment, the device 100 may display the object 210 currently displayed on the screen and a selected object of interest at the same time on the screen.

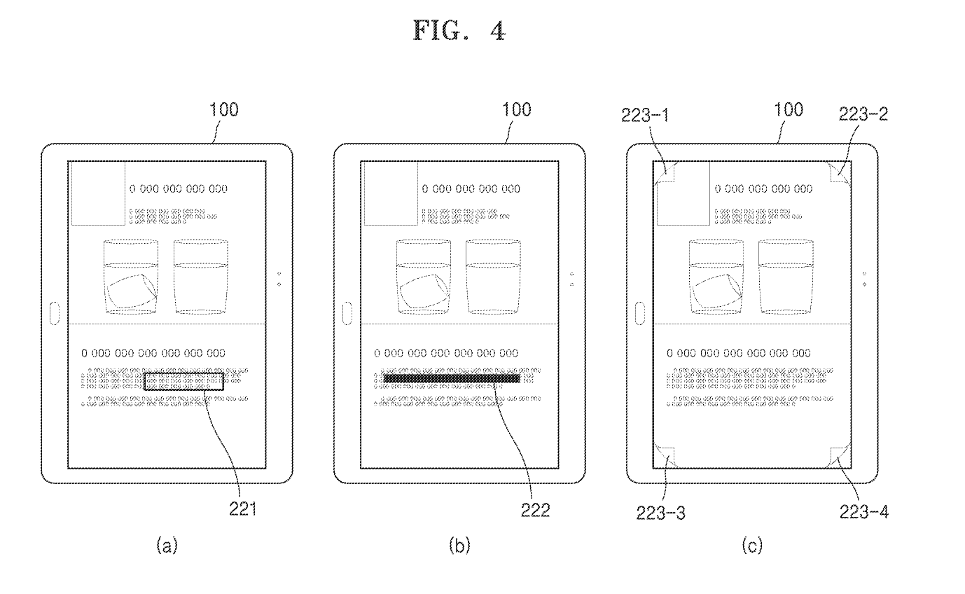

FIG. 4 is a diagram illustrating a method for the device 100 to determine different types of identifiers according to an exemplary embodiment.

Referring to FIG. 4, in an object displayed on the device 100, different types of identifiers may be displayed. A bookmark sign 221, an underline mark 222, and page folding marks 223-1 through 223-4 (hereinafter, will be referred to as 223) are displayed in objects of portions (a), (b), and (c), respectively, of FIG. 4. The device 100 may generate different identification information according to kinds of the displayed identifiers 221, 222 and 223.

Referring to the portion (a), when the device 100 determines an underline mark 221 in the object, the device may store first identification information of the underline mark 221 in metadata of the object. The device 100 may store the first identification information in metadata of each of objects of interest that are determined to include the underline mark 221 among objects available to be displayed when an application is executed.

Referring to the portion (b), when the device 100 determines a bookmark sign 222 in the object, the device 100 may store second identification information of the bookmark sign 222 in metadata on the object. The device 100 may store the second identification information in metadata of each of objects of interest that are determined to include the bookmark sign 222 among the objects available to be displayed when the application is executed.

Referring to the portion (c), when the device 100 determines the page folding mark 223 in the object, the device 100 may store third identification information of the page folding mark 223 in metadata on the object. The device may store the third identification information in metadata of each of objects of interest that are determined to include the page folding mark 223 among the objects available to be displayed when the application is executed.

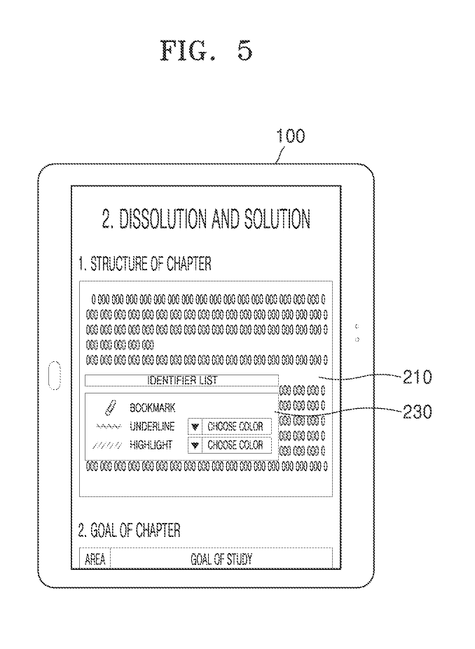

FIG. 5 is a diagram illustrating a method for the device 100 to display information of different types of identifiers according to an exemplary embodiment.

The device 100 displays the information of the types of identifiers. In detail, the device 100 displays a list 230 of the types of identifiers displayed in each of objects of interest (e.g., the object 210) available to be displayed when an application is executed. The types of identifiers may be classified according to kinds, shapes, and colors of identifiers. The user may select an identifier type displayed in an object of interest desired to be selected, from the list 230 of the types of identifiers that is displayed on the device 100. The device 100 may display an identification information region corresponding to the identifier type selected by the user. For example, when the user selects a bookmark sign from the list 230 of the types of identifiers, the device 100 may display the identification information regions 220 of the objects of interest each including a bookmark sign among the objects of interest available to be displayed when the application is executed.

Meanwhile, in the list 230 of the types of identifiers, additional information of the objects of interest on which respective identifiers are displayed may be displayed together with information of the types of identifiers. For example, when the user selects the bookmark sign in the list 230 of the types of identifiers, sequence information or title information of the objects of interest each including a bookmark sign may be displayed in the displayed identification information regions 220 of the objects of interest. Based on the additional information displayed in the identification information regions 220, the user may more easily search for objects of interest desired to be selected.

FIG. 6 is a diagram illustrating a method for the device 100 to display the identification information regions 220 on the device 100 according to an exemplary embodiment.

When a request from a user for a plurality of identification information regions indicating respective objects of interest is obtained, the device 100 determines objects of interest of which identification information is generated, among objects available to be displayed when an application is executed. The device 100 displays identification information regions 220 indicating the respective determined objects of interest on the device 100.

Referring to FIG. 6, the device 100 displays the identification information regions 220 on a side surface of the device 100. However, this is just an exemplary embodiment, and the device 100 may display the identification information regions 220 on two or more side surfaces of the device 100. Information of identifiers displayed in the objects of interest corresponding to the respective identification information regions 220 may be displayed in the identification information regions 220. For example, when an identifier displayed in an n-th object of interest is a bookmark sign, the bookmark sign may be displayed in the identification information region of the n-th object of interest.

In each of the identification information regions 220, additional information of the corresponding objects of interest may be displayed. Also, if the user selects any of additional information items, the device 100 may display the selected additional information item in the identification information regions 220. For example, when a digital book application is executed in the device 100, a page number of each page forming the digital book application may be displayed according to a selection by the user.

Meanwhile, the device 100 may display the identification information regions 220 based on sequence information of the objects of interest. For example, when the device 100 executes the digital book application, the device 100 may sequentially display the identification information regions 220 of the objects of interest, based on the sequence information of the objects of interest on which a bookmark sign is displayed.

FIG. 7 is a diagram illustrating a method for the device 100 to display the identification information regions 220 on the device 100 according to another exemplary embodiment.

The identification information regions 220 may provide guide information to display a plurality of objects of interest on the device 100. In this example, in order to more easily provide the guide information for a user, the device 100 displays the identification information regions 220 together with thumbnail images 250 of the objects of interest corresponding to the respective identification information regions 220. Also, the device 100 may provide the thumbnail images 250 as identification information regions for the user. Meanwhile, this is just an exemplary embodiment, and other exemplary embodiments are not limited by this.

According to another exemplary embodiment, the device 100 may display the thumbnail images 250 as additional information of identification information regions 220. For example, in a state where the identification information regions 220 are displayed on the device 100, if a double tap input or a motion 30 is obtained from the user, the device 100 may display the identification information regions 220 together with thumbnail images 250 of the objects of interest corresponding to the respective identification information regions 220.

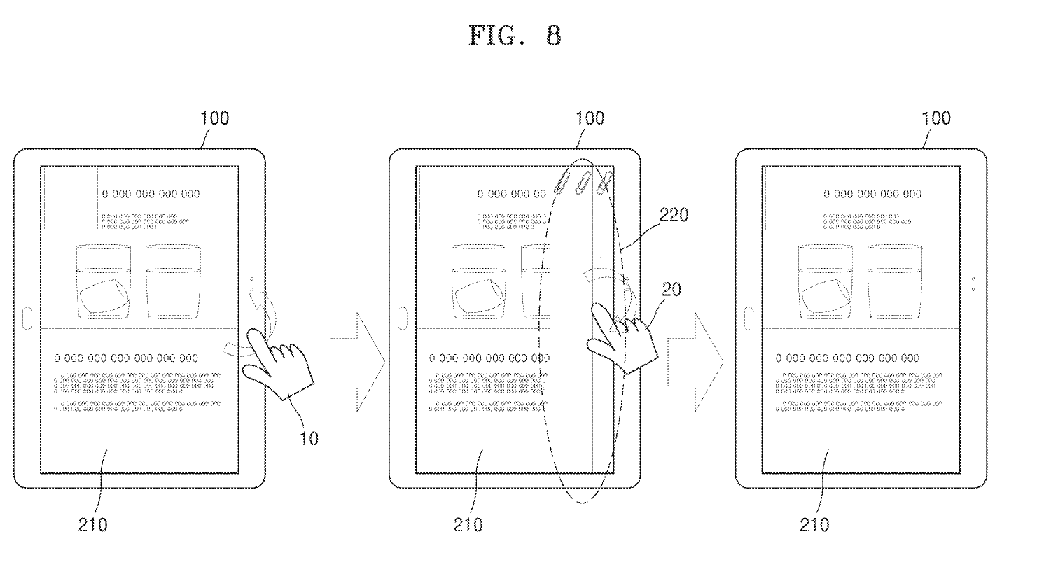

FIG. 8 is a diagram illustrating a method for the device 100 to display the identification information regions 220 based on a user input according to an exemplary embodiment.

Referring to FIG. 8, when a request from a user to display the identification information regions 220 corresponding to the respective objects of interest (i.e., the identification information requesting input 10) is obtained, the device 100 displays the identification information regions 220 on a side surface of the device as a response to the request. For example, when the identification information requesting input 10 from the user in which a touch input and a swiping upwards input are combined is obtained, the device 100 may display the identification information regions 220 on the side surface. However, this is just an exemplary embodiment, and the request to display the identification information regions 220 may be generated not only by the identification information requesting input 10 in which the touch input and the swiping upwards input are combined. For example, when a touch input and a hovering input from the user are obtained, the device may display the identification information regions 220 on the side surface of the device 100.

Meanwhile, the device 100 obtains a request from the user to delete the displayed identification information regions 220. For example, when an input 20 from the user in which a touch input and a swiping downwards input are combined is obtained, the device deletes the identification information regions 220 displayed on the side surface of the device 100. However, this is just an exemplary embodiment, and the request to delete the displayed identification information regions 220 is generated not only by the input 20 in which the touch input and the swiping downwards input are combined.

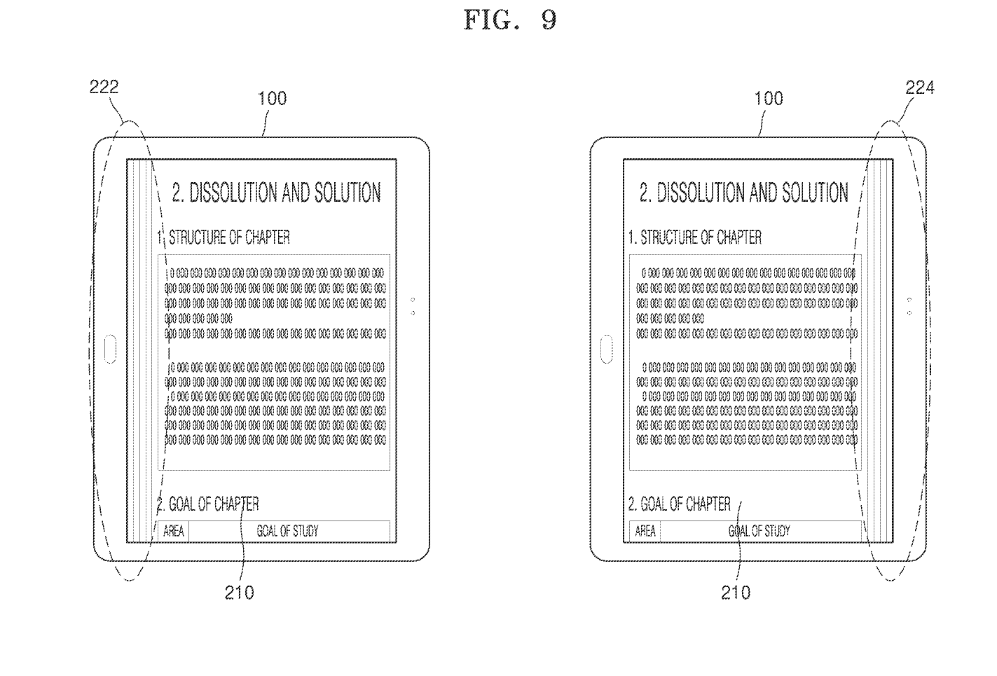

FIG. 9 is a diagram illustrating a method for a device 100 to determine a location and a range of an identification information region to be displayed, based on a user input according to an exemplary embodiment.

According to sequence information of objects of interest corresponding to identification information regions, the device 100 determines a location in which the identification information regions are displayed. For example, when a digital book application is being executed, an n-th page (i.e., the object 210) may be displayed on the device 100. When a request from a user for displaying identification information regions is received, the device 100 may determine pages of interest. Based on sequence information of the determined pages of interest, the device 100 may classify the pages of interest into those including sequence information preceding the n-th page and those including sequence information succeeding the n-th page.

The device 100 may determine locations on the device in which respective identification information regions 222 and 224 of the classified pages of interest are displayed. The device 100 may display the first identification information regions 222 of the pages of interest including the preceding sequence information on a first side surface of the device 100 and the second identification information regions 224 of the pages of interest including the succeeding sequence information on a second side surface of the device 100.

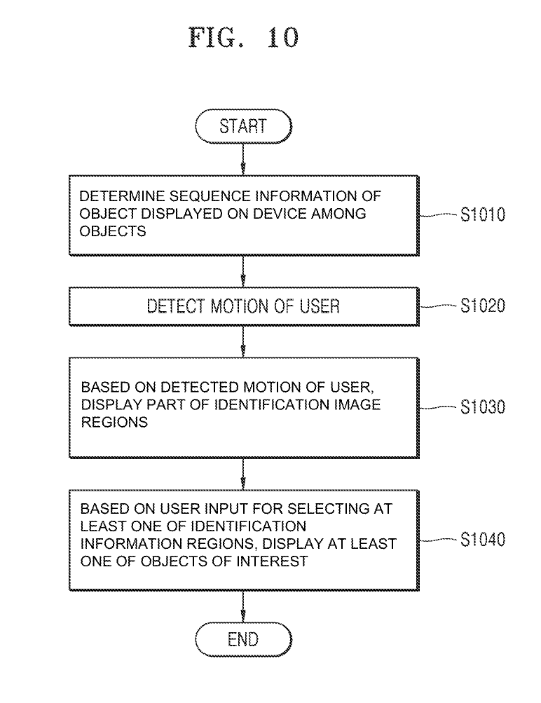

FIG. 10 is a flowchart of a method for a device 100 to detect a motion of a user and display additional information of objects of interest corresponding to the identification information regions 220 according to an exemplary embodiment.

In operation S1010, the device 100 determines sequence information of the object 210 displayed on the device 100 among objects. The device 100 may determine sequence information of which point, in a sequence of the objects included in contents, the object 210 currently displayed on the device 100 is positioned. Operation S1010 may correspond to operation S220 of FIG. 2.

In operation S1020, in a state where the identification information regions 220 of the objects of interest are displayed, the device 100 detects the motion of the user. For example, when a hand of the user stays within a predetermined distance from a screen of the device 100 longer than a preset time period, the device 100 may detect this as the motion of the user.

In operation S1030, based on the detected motion of the user, the device 100 may display a part of the identification information regions 220 on the device 100. For example, the device 100 may display the identification information regions 220 of the objects of interest whose sequence information is included in a preset range from the currently displayed object 210.

Also, the device 100 may display the additional information together with the identification information regions 220 of the objects of interest whose sequence information is included in the preset range from the currently displayed object 210. For example, when the currently displayed object 210 is an n-th object, the device 100 may display, on the device 100, the identification information regions 220 of the objects of interest from an (n-m)-th object to an (n+m)-th object, and the corresponding additional information such as thumbnail images.

In operation S1040, based on a user input for selecting at least one of the identification information regions 220 of the objects of interest and the additional information of the objects of interest, the device 100 displays at least one of the objects of interest. For example, the device 100 may obtain a user input for selecting identification information region A corresponding to object of interest A among the identification information regions 220 of the objects of interest. Also, the device 100 may obtain a user input for selecting additional information A corresponding to the object of interest A among the additional information items of the objects of interest.

The device 100 displays an object of interest corresponding to the identification information region or additional information selected according to the user input. For example, the device 100 may display the object of interest A corresponding to the identification information region A or the additional information A selected according to the user input.

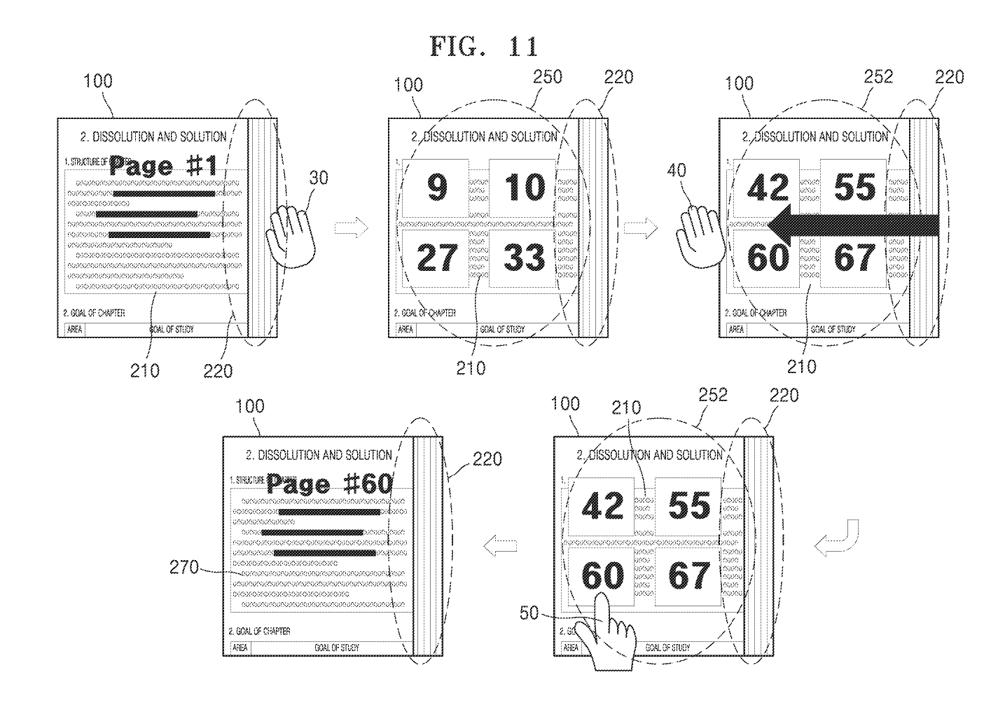

FIG. 11 is a diagram illustrating a method for the device 100 to detect a motion of a user and display the thumbnail images 250 of an object of interest according to an exemplary embodiment.

In a state where the identification information regions 220 of objects of interest are displayed, the device 100 detects the motion 30 of the user. In this example, the device detects the motion 30 of a hand of the user staying within a predetermined height from the identification information regions 220 displayed on the device 100 longer than a preset time period (hereinafter will be referred to as the holding motion 30).

Based on the detected holding motion 30, the device 100 displays the thumbnail images 250 of predetermined objects of interest on the device 100. For example, the device 100 may display, on the device 100, the thumbnail images 250 of the objects of interest whose sequence information is included in a preset range from sequence information of the currently displayed object 210, e.g., page #1 of a digital book.

In a state where the thumbnail images 250 of the objects of interest whose sequence information is included in the preset range from the sequence information of the currently displayed object 210 are displayed, the device 100 detects a motion 40 of the user. In this example, when the device 100 detects the motion 40 of a hand of the user traveling from a side surface to another side surface (hereinafter will be referred to as the traveling motion 40), the device 100 changes the thumbnail images 250 of the predetermined objects of interest displayed on the device 100 into thumbnail images 252 on other objects of interest.

The device 100 detects a motion 50 of the user selecting any of the changed thumbnail images 252 (hereinafter will be referred to as the selection motion 50). The device 100 may display an object of interest 270 (e.g., page #60 of the digital book) corresponding to a thumbnail image selected by the selection motion 50 of the user among the thumbnail images 252.

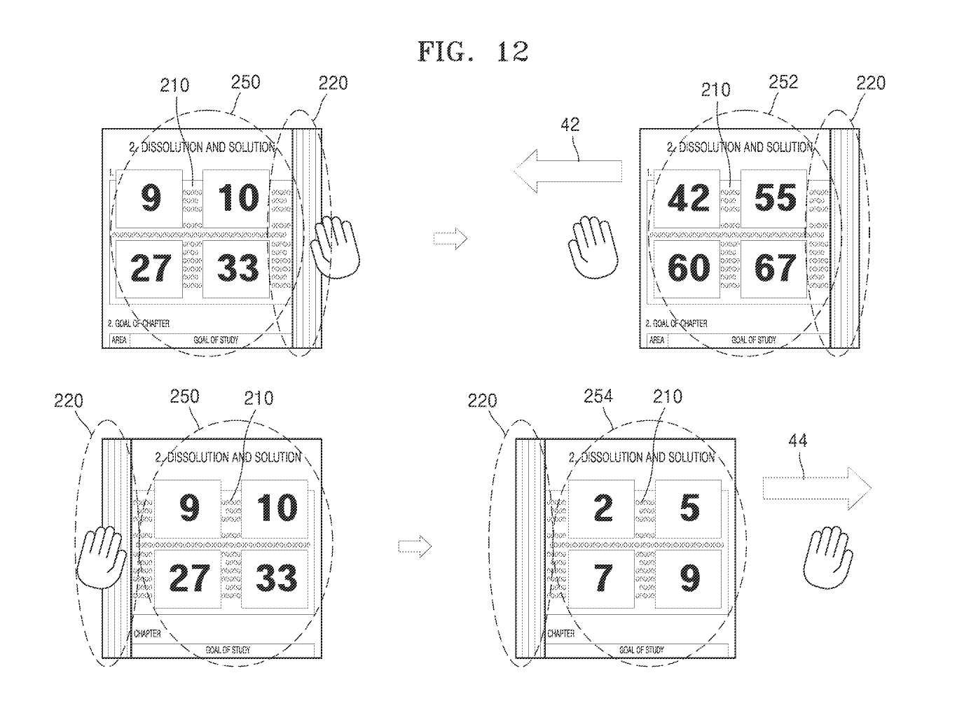

FIG. 12 is a diagram illustrating a method for a device 100 to change the thumbnail images 250 displayed on the device 100 based on traveling motions 42 and 44 of a user according to an exemplary embodiment.

The device 100 detects the traveling motions 42 and 44 of a hand of the user that travels from any side surface to the other side surface of the device 100. Also, the device 100 may determine the direction in which the hand of the user moves. In this example, the device 100 detects the first traveling motion 42 in which the hand of the user moves from a right-hand side to a left-hand side of the device, and the second traveling motion 44 in which the hand moves from the left-hand side to the right-hand side.

When a digital book application is being executed, an n-th page (i.e., the object 210) is displayed on the device 100. Also, on the device 100, the thumbnail images 250 of pages of interest whose page sequence information is included in a preset range from sequence information of the n-th page are displayed together with the identification information regions 220 of the pages of interest.

Based on the sequence information of the determined pages of interest, if the first traveling motion 42 is detected, the device 100 displays thumbnail images 252 of pages of interest having sequence information succeeding the pages of interests of the displayed thumbnail images 250. Based on the sequence information of the determined pages of interest, if the second traveling motion 44 is detected, the device 100 displays thumbnail images 254 of pages of interest having sequence information preceding the pages of interests of the displayed thumbnail images 250.

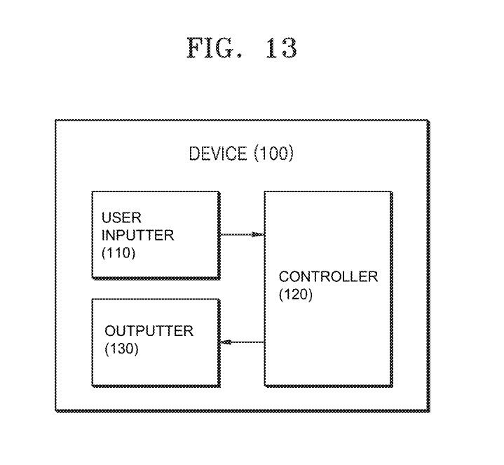

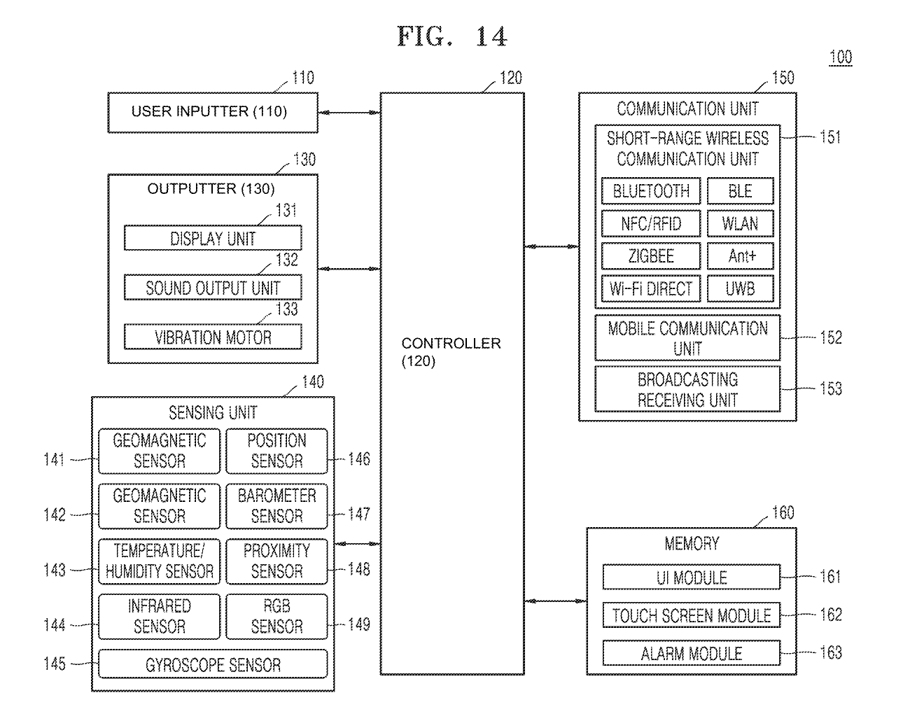

FIGS. 13 and 14 are block diagrams of a device for displaying an object according to an exemplary embodiment. As shown in FIG. 13, the device 100 includes a user inputter 110, a controller 120, and an outputter 130.

However, not all the shown elements are essential elements. The device 100 may be implemented with more elements than the shown elements, and may also be implemented with less elements.

For example, as shown in FIG. 14, the device 100 further includes a sensing unit 140, a communication unit 150, and a memory 160 in addition to the user inputter 110, the controller 120, and the outputter 130.

The elements will now be explained one by one.

The user inputter 110 is a unit for a user to input data to control the device. For example, the device 100 may have a key pad, a dome switch, a touchpad (a contact-type capacitance method, a pressure-type resistive overlay method, an infrared sensing method, a surface ultrasound transmission method, an integral tension measuring method, a piezo effect method and the like), a jog wheel and a jog switch, but the user inputter 110 is not limited by these.

The user inputter 110 may receive a user input. For example, the user inputter 110 may receive a request from a user to determine a plurality of objects of interest having identification information among objects displayed on the device 100. Also, the user input 110 may obtain a user input for selecting at least one of identification information regions on each of the objects of interest determined in the controller 120.

The controller 120 normally controls the overall operations of the device 100. For example, by executing programs stored in the memory, the controller 120 may generally control the user inputter 110, the outputter 130, the sensing unit 140, and the communication unit 150.

In response to the user request, the controller 120 may determine objects of interest having identification information among objects available to display when an application is executed in the device 100. Meanwhile, identification information is generated by the controller 120 and when an identifier is displayed on an object, the controller 120 may generate identification information. Also, the controller 120 may determine the type of at least one identifier displayed on an object of interest. Based on the type of the at least one identifier, the controller 120 may generate different identification information.

Meanwhile, the controller 120 may detect an object of interest corresponding to an identification information region determined by a user input. The controller 120 may control the output unit such that a detected object of interest is displayed on the device 100.

Also, based on a user input, the controller 120 displays an object of interest corresponding to sequence information preceding or succeeding the determined sequence information.

The outputter 130 is to output an audio signal, a video signal or a vibration signal, and may include a display unit 131, a sound output unit 132 and a vibration motor 133.

The display unit 131 displays and outputs information processed in the device 100. For example, when an application is executed, the display unit 131 may display at least one object including information related to the execution of the application.

The display unit 131 may display identification information regions 220 displaying objects of interest including identification information based on a user input. Also, when the user selects any one of identification information regions 220, the display unit 131 may display an object of interest corresponding to the selected identification information region.

Meanwhile, when the display unit 131 and a touchpad forming a layer structure are formed as a touch screen, the display unit 131 may be used as an input device as well as an output device. The display unit 131 may include at least one of a liquid crystal display, a thin film transistor-liquid crystal display, an organic light-emitting diode, a flexible display, a 3D display and an electrophoretic display. According to the type of implementation of the device 100, the device 100 may include two or more display units 131. In this case, two or more display units 131 may be provided to face each other by using a hinge.

The sound output unit 122 outputs audio data received from the communication unit 150 or stored in the memory 160.

Also, the sound output unit 122 outputs a sound signal related to functions which are performed in the device 100 (for example, a call signal receiving sound, a message receiving sound, and an alarm sound). In this sound output unit 122 a speaker and a buzzer may be included.

The vibration motor may output a vibration signal. For example, the vibration motor 123 may output a vibration signal corresponding to an output of audio data or video data (for example, a call signal receiving sound and a message receiving sound). Also, the vibration motor 123 may output a vibration signal when a touch is input on a touch screen.

The sensing unit 140 may sense the state of the device 100 or the state of the surroundings of the device 100, and transfer the detected information to the controller 120.

The sensing unit 140 may include at least one of a magnetic sensor 141, an acceleration sensor 142, a temperature and/or humidity sensor 143, an infrared sensor 144, a gyroscope sensor 145, a positional sensor 146 (for example, GPS), a barometer sensor 147, a proximity sensor 148 and an RGB sensor or illumination sensor 149, but is not limited by these. The function of each sensor may be understood intuitively from the name by a person skilled in the art and detailed explanation will be omitted here.

The sensing unit 140 may detect a motion of the user. For example, the sensing unit 140 may detect a holding motion 30 of the user in which a hand of the user stays within a preset height from identification information regions 220 displayed on the device 100. Also, the sensing unit 140 may detect a traveling motion 40 in which an input means of the device 100 such as a hand of the user moves from one side surface to the other side surface. The sensing unit 140 may transmit information on the detected motion to the controller 120.

Based on the motion detected in the sensing unit 140, the control unit 130 may control operations of the device 100.

The operation of the device corresponding to the motion detected in the sensing unit 140 is the same as described above.

The communication unit 150 may include one or more elements enabling communication between the device 100 and an external device or a server. For example, the communication unit 150 may include a short-range wireless communication unit 151, a mobile communication unit 152 and a broadcasting receiving unit 153.

The short-range wireless communication unit 151 may include a Bluetooth communication unit, a Bluetooth low energy (BLE) communication unit, a near field communication unit, a WLAN (Wi-Fi) communication unit, a Zigbee communication unit, an infrared Data Association (IrDA) communication unit, a Wi-Fi Direction (WFD) communication unit, an ultra wideband (UWB) communication unit and Ant+ communication, but is not limited by these.

The mobile communication unit 152 transmits a wireless signal to, and receives a wireless signal from at least one of a base station, an external terminal and a server on a mobile communication network. Here, the wireless signal may include a voice call signal, video conversation call signal or a variety of forms of data according to text and/or multimedia message transmission and reception.

The broadcasting receiving unit 153 receives a broadcasting signal and/or broadcasting related information from outside through a broadcasting channel. The broadcasting channel may include a satellite channel and a ground-wave channel. According to an implementation, the device 100 may not include the broadcasting receiving unit 153.

The memory 160 may store programs for processing and control by the controller 120 and data which is input and/or output (for example, objects including information required when an application is executed, and metadata on the objects).

The memory 160 may include a storage medium of at least any one type of a flash memory type, a hard disk type, a multimedia card micro type, a card type memory (for example, an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk and an optical disk. Also, the device 100 may operate a web storage performing a storage function of a memory on the Internet or a cloud server.

Programs stored in the memory 160 may be classified into a plurality of modules according to the functions, and for example, may be classified into a UI module 161, a touch screen module 162 and an alarm module 163.

The UI module 161 may provide a specialized UI or GUI linked to the device 100 according to each application.

The touch screen module 162 may detect a touch gesture of the user on the touch screen and transmit the information on the touch gesture to the controller 120. The touch screen module 162 according to the embodiment may recognize and analyze a touch code.

In order to detect a touch or proximity touch on the touch screen, a variety of sensors may be provided inside or in the proximity of the touch screen. As an example of a sensor to detect a touch on the touch screen, there is a tactile sensor. The tactile sensor is a sensor which senses a contact of a predetermined object the same as or more than a person senses.

The tactile sensor may detect a variety of information such as the roughness of a contact surface, the hardness of a contact object, and the temperature of a contact point.

Also, as an example of a sensor for sensing a touch on the touch screen, there is a proximity sensor.

The proximity sensor is a sensor which detects an object approaching to a predetermined detection surface, or the presence of an object existing in the proximity by using electromagnetic force or infrared without a mechanical contact. Examples of the proximity sensor include a transmission-type photoelectric sensor, a direct-reflecting photoelectric sensor, a mirror reflection type photoelectric sensor, a high frequency oscillation proximity sensor, a capacitance type proximity sensor, a magnetic type proximity sensor, and an infrared proximity sensor. The touch gesture of the user may include a tap, a touch & hold, a double tap, a drag, a panning, a flick, a drag and drop and a swipe.

The alarm module 163 may generate a signal to inform an occurrence of an event of the device 100. Examples occurring in the device 100 may include a call signal reception, a message reception, a user input and a notice of a schedule. The alarm module 163 may output an alarm signal in the form of a video signal through the display unit 121 or an alarm signal in the form of an audio signal through the sound output unit 122 or an alarm signal in the form of a vibration signal through the vibration motor 123.

The methods according to the exemplary embodiments may be implemented in the form of a program commands and recorded on a computer readable medium. The computer readable media may include individual program commands, data files, and data structures, or a combination of them. The program commands may be specially designed and formed for the exemplary embodiments, or may be available for use because these programs have been known to computer software industries. Examples of computer readable media include magnetic media such as hard disks, floppy disks and magnetic tapes, optical media such as CD-ROMs and DVDs, magneto-optical media such as floptical disks, and hardware devices specially designed to store and execute program commands such as ROMs, RAMs and flash memories. Examples of program commands include high-level language codes that may be executed by a computer by using an interpreter as well as machine codes that are generated by a compiler.

What is claimed is:

1. A method of displaying an object on a device, the method comprising:
generating identification information of objects of interest selected from objects available for displaying on the device based on preset sequence information;
determining sequence information of an object displayed on the device among the available objects; and
based on an input, displaying an object of interest corresponding to previous sequence information or following sequence information of the determined sequence information, among the objects of interest.

2. The method of claim 1, wherein the displaying of the object of interest comprises:
based on the input, detecting at least one of objects of interest corresponding to the previous sequence information or the following sequence information of the determined sequence information determined, among the objects of interest, based on the preset sequence information; and
sequentially displaying the detected at least one of the objects of interest.

3. The method of claim 1, wherein the generating of the identification information comprises:
selecting, as an object of interest, an object in which an identifier is displayed from the available objects.

4. The method of claim 3, wherein the generating of the identification information comprises:
determining a type of the identifier; and
generating the identification information to be different from each other based on the determined type of the identifier.

5. The method of claim 1, further comprising:
displaying identification information regions indicating respective objects of interest, the identification information regions being distinguishable based on an identifier displayed in each of the objects of interest.

6. The method of claim 5, wherein the displaying of the object of interest comprises:
displaying, in an identification information region among the identification information regions, an object of interest among the objects of interest that corresponds to the identification information region, based on a selection of the identification information region.

7. The method of claim 5, further comprising:
displaying thumbnail images of the respective object of interests.

8. The method of claim 5, wherein the displaying of the identification information regions comprises:
displaying the identification information regions on a side surface of the device based on sequence information of the objects of interest.

9. The method of claim 5, wherein the displaying of the identification information regions comprises:
detecting a motion; and
based on the detected motion, displaying a part of the identification information regions.

10. The method of claim 9, wherein the displaying of the part of the identification information regions comprises:
in response to the detected motion being a motion from a side surface of the device to another side surface of the device, displaying another part of the identification information regions.

11. A non-transitory computer-readable storage medium storing a program comprising instructions for causing a computer to perform the method of claim 1.

12. A device for displaying an object, the device comprising:
a controller configured to
generate identification information of objects of interest selected from objects available for displaying on the device based on preset sequence information, and
determine sequence information of an object displayed on the device among the available objects;
an outputter configured to, based on an input, display an object of interest corresponding to previous sequence information or following sequence information of the determined sequence information, among the objects of interest.

13. The device of claim 12, wherein:
the controller is further configured to, based on the input, detect at least one of objects of interest corresponding to the previous sequence information or the following sequence information of the determined sequence information determined, among the objects of interest, based on the preset sequence information; and
the outputter is configured to sequentially display the detected at least one of the objects of interest.

14. The device of claim 12, wherein the controller is configured to:
select, as an object of interest, an object in which an identifier is displayed from the available objects.

15. The device of claim 14, wherein the controller is configured to:
determine a type of the identifier; and
generate the identification information to be different from each other based on the determined type of the identifier.

16. The device of claim 12, wherein the outputter is further configured to:
display identification information regions indicating respective objects of interest, the identification information regions being distinguishable based on an identifier displayed in each of the objects of interest.

17. The device of claim 16, wherein the outputter is configured to:
display, in an identification information region among the identification information regions, an object of interest among the objects of interest that corresponds to the identification information region, based on a selection of the identification information region.

18. The device of claim 16, wherein the outputter is further configured to:
display thumbnail images of the respective object of interests.

19. The device of claim 16, wherein the outputter is configured to:
display the identification information regions on a side surface of the device based on sequence information of the objects of interest.

20. The device of claim 12, further comprising:
an inputter configured to detect a motion, and
wherein the outputter is configured to, based on the detected motion, display a part of the identification information regions.

21. The device of claim 20, wherein the outputter is further configured to:
in response to the detected motion being a motion from a side surface of the device to another side surface of the device, display another part of the identification information regions.
